(19) United States
(12) Patent Application Publication
(10) Pub. No.: US 2002/0073344 A1
(43) Pub. Date: Jun. 13, 2002

(54) Method and apparatus for preventing an unauthorized transaction

(76) Inventors: L. Michael Maritzen, Fremont, CA (US); Kiyohiko Niwa, Haworth, NJ (US); Yoshihiro Tsukamura, Cresskill, NJ (US); Harold Aaron Ludtke, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/929,960

(22) Filed: Aug. 15, 2001

Related U.S. Application Data
(60) Provisional application No. 60/254,337, filed on Dec. 8, 2000.

(51) Int. Cl. H04L 9/32

(52) U.S. Cl. 713/202

(57) ABSTRACT

A method, an apparatus, and a system that prevents an unscrupulous person from stealing the identity of another party and using the stolen identity to obtain a transaction device such as a biometric device that is configured to access, for example, a line of credit. In one aspect, a first biometric data of a party is registered (or stored) in a suitable manner with a trusted entity. The first biometric data may be fingerprint data, iris data, retinal data, voice data, or other suitable biometric information associated with a party. The trusted entity, for example, may be the party's bank. A second biometric data (e.g., fingerprint data) is obtained from a person seeking financial credit. The person is prevented from registering a second biometric data (e.g., fingerprint data of the unscrupulous person) that does not match the first biometric data (e.g., fingerprint data of the originally registered individual). This prevents the unscrupulous person from stealing the identity of another party.

### BACKGROUND OF THE INVENTION

This application claims the benefit of the earlier filing date of co-pending provisional application of Michael L. Maritzen, Kiyo Niwa, Yoshihiro Tsukamura, and Harold Aaron Ludtke entitled, “Method and Apparatus for Proactive Automated, Table-Driven Fraud Detection and Escalation in Real-Time at a Point-of-Sale Access Device,” Serial No. 60/254,337, filed Dec. 8, 2000, which is herein incorporated by reference.

### FIELD OF THE INVENTION

The present invention relates generally to authorization of electronic user transactions. More specifically, the invention relates to preventing an unscrupulous party from improperly obtaining the identity of a person to obtain or to use an asset of that person.

### BACKGROUND

Biometric devices are becoming increasingly important for ensuring the security of electronic transactions. U.S. Pat. No. 6,202,151 issued to Musgrave et al. (Musgrave) illustrates a system and a method for authenticating electronic transactions using biometric certificates. In Musgrave, biometric data such as a fingerprint is pre-stored in a database of a biometric certificate management system. A biometric device then senses biometric information such as a fingerprint from a person attempting to use the biometric device. This system determines whether a person is the authorized user of the biometric device by comparing the personal characteristics of the user against the biometric data stored in the database which is accessed over a network. One disadvantage to this system is that an unauthorized individual may attempt to access through the network the pre-certified biometric information in the database that then allows the unauthorized individual to obtain a variety of transaction information regarding the user. Moreover, Musgrave does not prevent an unauthorized individual from stealing the identity of another person and obtaining financial credit based upon the stolen identity.

Another patent, U.S. Pat. No. 6,219,439 issued to Burger (Burger), discloses that the biometric data (e.g., a fingerprint) of the person is stored directly on a chip in the biometric device. When the user attempts to use the biometric device, a reader coupled to the biometric device senses biometric information (e.g., fingerprint) from the user and the biometric device then compares that fingerprint to that which is stored on the chip of the biometric device. While Burger does prevent unauthorized use of the biometric device, Burger does not prevent the unauthorized use of someone's identity to obtain a line of financial credit at a financial institution such as a bank. For example, an unscrupulous person may obtain another person's social security number and apply for credit at the bank. The bank may then determine that the person with the stolen identity has good credit and extend credit to the unscrupulous person. The unscrupulous person subsequently obtains a blank biometric device and enters and stores his fingerprint on the biometric device. The biometric device then authorizes transactions when the unscrupulous party has his fingerprint scanned into the biometric device.

Musgrave and Burger also fail to disclose systems that earmark or set-aside funds of the owner of the biometric device while the transaction is completed in real-time. Additionally, neither of these patents disclose an automatic notification procedure if an unscrupulous party attempts to use another person's identity to obtain financial credit. It is therefore desirable to develop a method, an apparatus, or a system that addresses the disadvantages associated with conventional methods, devices, and systems.

### SUMMARY

A method, an apparatus, and a system are disclosed that prevent an unscrupulous person from stealing the identity of another party and using the stolen identity to obtain a transaction device such as a biometric device that is configured to access, for example, a line of financial credit. In one aspect, a first biometric data of a party is registered (or stored) in a suitable manner with a trusted entity. The first biometric data may be, for example, fingerprint data, iris data, retinal data, deoxyribonucleic acid (DNA) data, voice data, or other suitable biometric information of an authorized person. The trusted entity, for example, may be the party's bank.

A second biometric data (e.g., fingerprint data) is obtained from a person seeking financial credit. The person is prevented from registering the second biometric data (e.g., fingerprint data of the unscrupulous person) that does not match the first biometric data (e.g., registered fingerprint data of the authorized person). This prevents the unscrupulous person from stealing the identity of another party.

### BRIEF DESCRIPTION OF THE DRAWINGS

The present invention is illustrated by way of example and not limited in the figures of the accompanying drawings, in which like references indicate similar elements and in which:

FIG. 1 is a block diagram of one embodiment for a system that prevents an unscrupulous person from obtaining the identity of a party to gain access to an asset such as the financial credit history of another person;

FIG. 2 is a block diagram of one embodiment of a privacy card for a personal transaction device;

FIG. 3 is a block diagram of one embodiment of a digital wallet for a personal transaction device;

FIG. 4 is a block diagram of one embodiment of a secure transaction system; and

FIG. 5 is a flow diagram of one method for preventing an unscrupulous person from improperly obtaining financial credit based upon an identity of a party.

### DETAILED DESCRIPTION

In the following description, numerous specific details are set forth to provide a thorough understanding of the invention. However, it will be understood by one of ordinary skill in the art that the invention may be practiced without these specific details. In other instances, well known structures and techniques have not been shown in detail to avoid obscuring the invention.

To prevent an unauthorized person from stealing the identity of another person, techniques of the invention involve registration of the biometric data of an authorized person and storage of the biometric data directly on a chip in a transaction device that is configured to be used to perform electronic transactions. For the purpose of clarification, definitions of these terms are presented below. It will be appreciated, however, that the claimed invention is not limited by the definitions. A transaction is a completion of an act (or acts) such as the purchase of a product or a service as in a business deal. A product is defined as a good or other suitable item. The Uniform Commercial Code defines goods as “all things (including specially manufactured good) which are movable at the time of identification to the contract for sale other than the money in which the price is to be paid, investment securities and things in action. Goods also includes the unborn young of animals and growing crops and other identified things attached to realty as described in the section on goods to be several from realty (Section 2-107).” UCC §2-105. Service, on the other hand, is defined as a duty or as labor to be rendered by one person to another. Given these definitions, registration of biometric data and use of the transaction device is presented below.

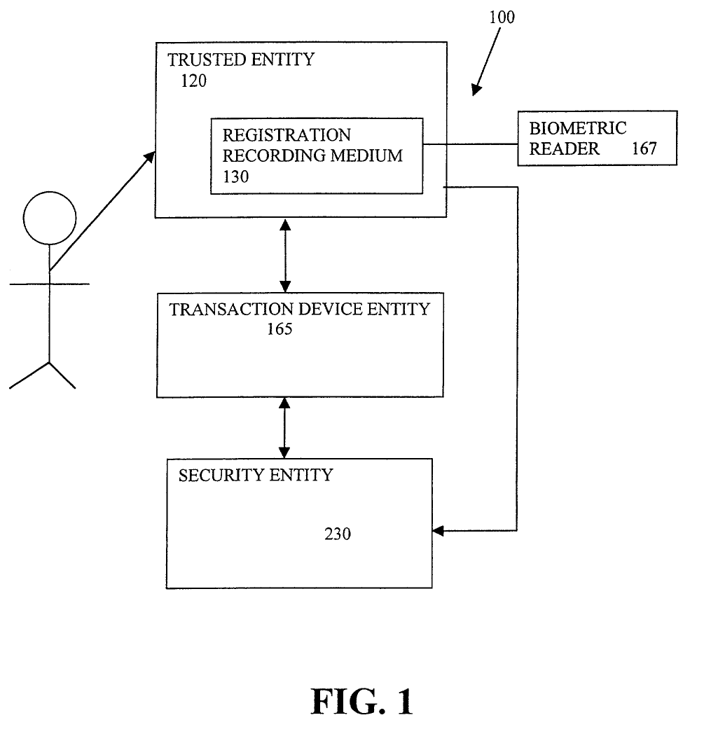

FIG. 1 is a block diagram for one embodiment of secured transaction system 100 that is configured to prevent an unscrupulous person from improperly using the identity of another party to obtain access to a valuable asset of that party such as his or her financial credit history. In one embodiment, the party may prevent his identity from being stolen by registering his biometric data (e.g., data such as his fingerprint data, iris data, retinal data, DNA data, voice data, face recognition data, etc.) with trusted entity 120. Registration of biometric information is now described.

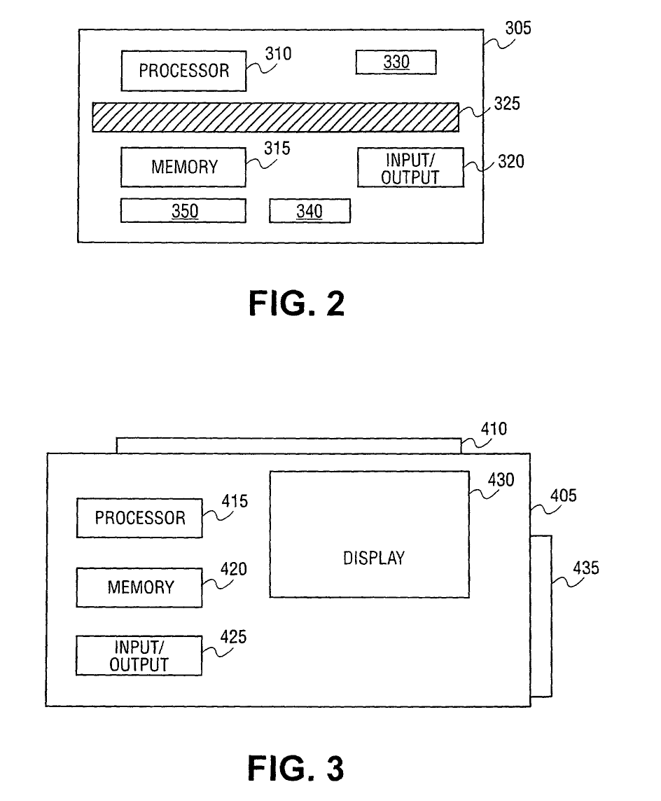

System 100 shows a party who registers (or stores) his biometric data with trusted entity 120, which is any organization to which a party entrusts his or her biometric information such as banks, government organizations such as the Federal Social Security Administration, companies that issue a personal transaction device ((PTD), e.g., a privacy card, or a privacy card coupled to a digital wallet as described below in conjunction with FIGS. 2 and 3) or other suitable organizations. Individuals may be encouraged to voluntarily provide biometric data to trusted entity 120 in order to prevent their identity from being stolen. Transaction device entities 165 that issue PTDs associated with a line of credit should also find it desirable to check the biometric data received from a person against any available biometric data stored at trusted entity 120 in order to avoid potential losses due to an unscrupulous party stealing the identity of another person.

To register biometric information with trusted entity 120, the party allows his unique biological data to be scanned or read by biometric reader 167 electronically coupled to a secure registration recording medium 130. Biometric readers 167 are commercially available from Sony Corporation located in Woodcliff Lake, N.J.

After the biometric data has been read, the biometric data is then stored into registration recording medium 130. Registration recording medium 130 is a storage device such as a database that is configured to receive and store a plurality of biometric data (e.g., fingerprint data, iris data, retinal data, etc.) that is associated with a single person. In one embodiment, deoxyribonucleic acid (DNA) of the person may be used as a master unique identifier and a variety of other biometric information such as fingerprint data, iris data, retinal data, voice data, facial data, or other biometric data from the person may be associated with the DNA.

If the person registers more than one biometric data, system 100 offers greater flexibility to transaction device entities 165 since one transaction device entity (e.g., a bank or credit-card company) may wish to check a fingerprint at trusted entity 120 for verification of a person's identity to obtain financial credit whereas another transaction device entity may prefer to check a person's iris data against that which is stored at trusted entity 120.

Trusted entity 120 may interface with security entity 230 by notifying security entity 230 in real-time using conventional means if an unscrupulous party attempts to improperly use a valuable asset of another person such as the person's financial credit history. Security entity 230 is a party charged with the duty of preventing or arresting an unscrupulous party for either attempting or gaining unauthorized access to another's asset. Examples of security entity 230 include the police, agents from a federal agency such as the Federal Bureau of Intelligence, private security guards, or other like persons or organizations.

Trusted entity 120 determines that an unscrupulous party is attempting to improperly use a valuable asset of another person by a variety of ways. First, the unscrupulous party may attempt to register his biometric data (referred to herein as the second biometric data) with trusted entity 120. Trusted entity 120 senses the second biometric data through biometric reader 167 and then compares that sensed biometric data with the first biometric data using a processor (not shown) coupled to registration recording medium 130. The processor is configured to perform two tasks: (1) deny registration to the unscrupulous party when the comparison of the unscrupulous party's biometric data does not match the authorized individual's biometric data, and (2) notify security entity 230. The biometric data may also be compared manually but this is not as efficient as using a processor. Second, trusted entity 120 may be asked by transaction device entity 165 to compare the biometric data sensed from a person seeking a transaction device to that which is stored in registration recording medium 130. If the sensed biometric data does not match the stored biometric data, trusted entity 120 notifies security entity 230 and transaction device entity 165 of the discrepancy.

Notification of security entity 230 may occur through a variety of means such as through wireless communication between a computer system (not shown) located at trusted entity 120 or transaction device entity 165 and security entity 230. This potentially allows security entity 230 to apprehend a criminal before he or she leaves the physical area where he or she tried to gain access to the financial credit of another person. In contrast, conventional systems typically do not contact security entity 230 until after they have determined an unscrupulous person has improperly accessed the financial credit of another person and has executed often numerous transactions with a credit card, usually much later.

After an authorized person's biometric information has been properly registered with trusted entity 120, the authorized person's biometric data is stored onto the PTD by trusted entity 120 (on behalf of transaction device entity 165 ) or transaction device entity 165 that issues PTDs after verifying a person's identity with trusted entity 120. Provided below is a detailed description of the PTD and the manner in which the PTD may be used in performing an electronic transaction.

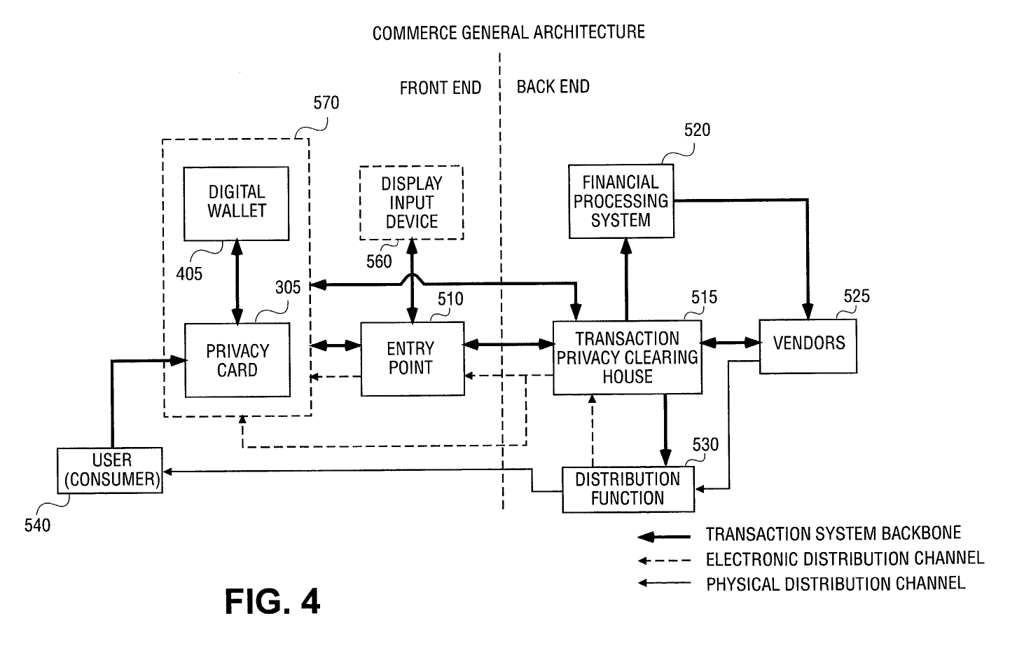

A user connects to and performs transactions with a secure transaction system such as that which is shown in FIG. 4 through PTD 570 that has a unique identifier (ID). In one embodiment, a privacy card is used as illustrated in FIG. 2. In an alternate embodiment, FIG. 3 illustrates a digital wallet that is used. In yet another alternate embodiment, a privacy card in conjunction with a digital wallet may be used.

Referring to FIG. 2, privacy card 305 is configured to be the size of a credit card. Privacy card 305 includes processor 310, memory 315 and input/output logic 320. Processor 310 is configured to execute instructions to perform the functionality herein. One set of instructions is configured to compare the biometric data of the authorized person stored in memory 315 to the biometric information of an authorized person attempting to use privacy card 305. The instructions may be stored in memory 315. Memory 315 is also configured to store data, such as transaction data, a first biometric data (e.g., fingerprint data, iris data, retinal data, voice data, facial data, etc.) that is associated with a registered party, or other suitable information. In one embodiment, memory 315 stores the transaction ID used to perform transactions. In one embodiment, the transaction ID identifies the PTD without disclosing the identity of the person authorized to use the PTD. In another embodiment, processor 310 may be replaced with specially configured logic to perform the functions described here.

Input/output logic 320 is configured to enable privacy card 305 to send and to receive information. In one embodiment, input/output logic 320 is configured to communicate through a wired or contact connection. In another embodiment, input/output logic 320 is configured to communicate through a wireless or contactless connection. A variety of communication technologies may be used.

In one embodiment, display 325 is used to generate bar codes scanable by coupled devices and used to perform processes as described herein. Privacy card 305 may also include a magnetic stripe generator 340 to simulate a magnetic stripe readable by devices such as legacy point-of-sale (POS) terminals.

In one embodiment, biometric information, such as fingerprint recognition, is used as a security mechanism that limits access to privacy card 305 to authorized users. A biometric reader such as a fingerprint touch pad and associated logic 330 is therefore included in one embodiment to perform these functions. Alternately, security may be achieved using a smart card chip interface 350, which uses well known smart card technology to perform the function.

Memory 315 can have a transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 315 can also have user identity/account information block. The user identity/account information block stores data about the user and accounts that are accessed by the card. The type of data stored includes the meta account information used to identify the account to be used.

One embodiment of digital wallet 405 is illustrated in FIG. 3. Digital wallet 405 includes coupling peripheral port 435 for input from privacy card 305, processor 415, memory 420, input/output logic 425, display 430, and peripheral port 410. Processor 415 is configured to execute instructions, such as those stored in memory 420, to perform the functionality described herein. Memory 420 may also store data including financial information, eCoupons, shopping lists and the like. Digital wallet 405 may be configured to have additional storage. In one embodiment, the additional storage is in a form of a card that couples to the device through peripheral port 410.

In one embodiment, privacy card 305 couples to digital wallet 405 through peripheral port 410; however, privacy card 305 may also couple to digital wallet 405 through another form of connection including a wireless connection.

Input/output logic 425 provides the mechanism for digital wallet 405 to communicate information. In one embodiment, input/output logic 425 provides data to a POS terminal or to privacy card 305 in a pre-specified format. The data may be output through a wired or wireless connection.

Digital wallet 405 may also include display 430 for display of status information to the user. Display 430 may also provide requests for input and may be a touch sensitive display, enabling the user to provide the input through the display.

The physical manifestation of many of the technologies in digital wallet 405 may likely be different from those in privacy card 305, mainly because of the availability of physical real estate in which to package technology. Examples of different physical representations would include the display, fingerprint recognition unit, etc. Given this description of PTDs, a description of how the PTD may be used in a secure transaction system is presented.

After transaction device entity 165 has verified a person's identity as described above in conjunction with FIG. 1, transaction device entity 165 stores the person's biometric data (also referred to herein as the “first biometric data”) onto PTD 570 (shown in FIG. 4) and provides PTD 570 to the person. PTD 570 allows the person to perform a variety of electronic transactions such as purchase a product or a service from a supplier. Alternatively, PTD 570 may be used to unlock a device (e.g., lock to an automobile, a lock to a door, etc.) or other suitable device. In yet another embodiment, PTD 570 may be used to activate a device such as an automobile, provided that the biometric data sensed from the user matches the biometric data stored on the PTD 570.

In one embodiment, to perform the transaction, the person inputs his biometric data (also referred to herein as a second biometric data) by using a biometric reader coupled to or that is part of PTD 570. After the second biometric data has been input, the second biometric data is compared to the first biometric data using program instructions executed on the processor of PTD 570. If the second biometric data does not match the first biometric data, the PTD does not allow, for example, access to a network such as the Internet to occur. If the second biometric data matches the first biometric data, the electronic transaction is authorized. In one embodiment, the electronic transaction may automatically transfer funds in real-time from the user's account that has a line of credit to the supplier's account. This task may be accomplished through wireless communication, networked communication, or other suitable communication between the transaction device and the user's financial account and then to the supplier's account.

In another embodiment, the person may wish to prevent disclosure of his identity to a supplier by using a secure transaction system in conjunction with the PTD. FIG. 4 is a block diagram of one embodiment of a secure transaction system, which may be used in electronic commerce. In this embodiment, a transaction privacy clearing house (TPCH) 515 may be used to interface with the user (or also referred to as the consumer) 540 and vendor 525. In this particular embodiment, PTD 570, e.g., privacy card 305, or a privacy card 305 coupled to a digital wallet 405, is used to maintain the privacy of the user while enabling the user to perform transactions. In an alternate embodiment, PTD 570 may be any suitable device that allows unrestricted access to TPCH 515. The personal transaction device information is provided to TPCH 515 that then indicates to vendor 525 and user 540 approval of the transaction to be performed.

In order to maintain confidentiality of the identity of user 540, the transaction device information does not provide user identification information. Thus, vendor 525 or other entities do not have user information but rather maintain transaction device information. TPCH 515 maintains a secure database of transaction device information and user information. In one embodiment, TPCH 515 interfaces to at least one financial processing system 520 to perform associated financial transactions, such as confirming sufficient funds to perform the transaction, and transfers to vendor 525 the fees required to complete the transaction. In addition, TPCH 515 may also provide information through distribution function 530 that, in one embodiment, may provide a purchased product to user 540, again without vendor 525 knowing the identification of user 540. In an alternate embodiment, financial processing system 520 need not be a separate entity but may be incorporated with other functionality. For example, in one embodiment, financial processing system 520 may be combined with TPCH 515 functionality.

In one embodiment, financial processing system 520 performs tasks of transferring funds between the user's account and the vendor's account for each transaction. In one embodiment, the presence of TPCH 515 means that no details of the transactions, other than the amount of the transactions and other basic information (such as an account number), are known to financial processing system 520. TPCH 515 issues transaction authorizations to financial processing system 520 function on an anonymous basis on behalf of the user over a highly secure channel. Financial processing system 520 does not need to have many electronic channels receiving requests for fund transfer, as in a traditional financial processing system. In one embodiment, a highly secure channel is set up between TPCH 515 and financial processing system 520; thus, financial processing system 520 is less vulnerable to spoofing.

In one embodiment, financial processing system 520 is contacted by TPCH 515 requesting a generic credit approval of a particular account. Thus, financial processing system 520 receives a minimal amount of information. In one embodiment, the transaction information, including the identification of goods being purchased with the credit need not be passed to financial processing system 520. TPCH 515 may request the credit using a dummy charge ID that can be listed in the monthly credit statement sent to the user, so that the user can reconcile his credit statement. Further, PTD 570 may include functionality to cause the credit statement to convert the dummy charge ID back to the transactional information so that the credit statement appears to be a conventional statement that lists the goods that were purchased and the associated amount charged.

A display input device 560 (shown in phantom) may be included to enable the user, or in some embodiments vendor 525, to display status and provide input regarding PTD 570 and the status of the transaction to be performed.

In yet another embodiment, entry point 510 interfaces with PTD 570 and also communicates with TPCH 515. Entry point 510 may be an existing (referred to herein as a legacy POS terminal) or a newly configured POS terminal located in a retail environment. User 540 uses PTD 570 to interface to the POS terminal in a manner similar to how credit cards and debit cards interface with POS terminals. Entry point 510 may also be a public kiosk, a personal computer, or the like.

The system described herein may also provide a distribution function 530 whereby products purchased via the system are distributed. In one embodiment, the distribution function 530 is integrated with TPCH 515 functionality. In an alternate embodiment, the distribution function 530 may be separate from TPCH 515. Utilizing either approach, the system ensures user privacy and data security. The distribution function 530 interacts with the user through PTD 570 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, a “package distribution kiosk” is used that allows the user to retrieve the package from the kiosk in a secure fashion. However, in one embodiment, the user may use PTD 570 to change the shipping address of the product at any time during the distribution cycle.

The components of a secure transaction system illustrated in FIGS. 2, 3, and 4 are further described in PCT published patent application number US00/35619, which is assigned to the same assignee as the present application and that is hereby incorporated by reference.

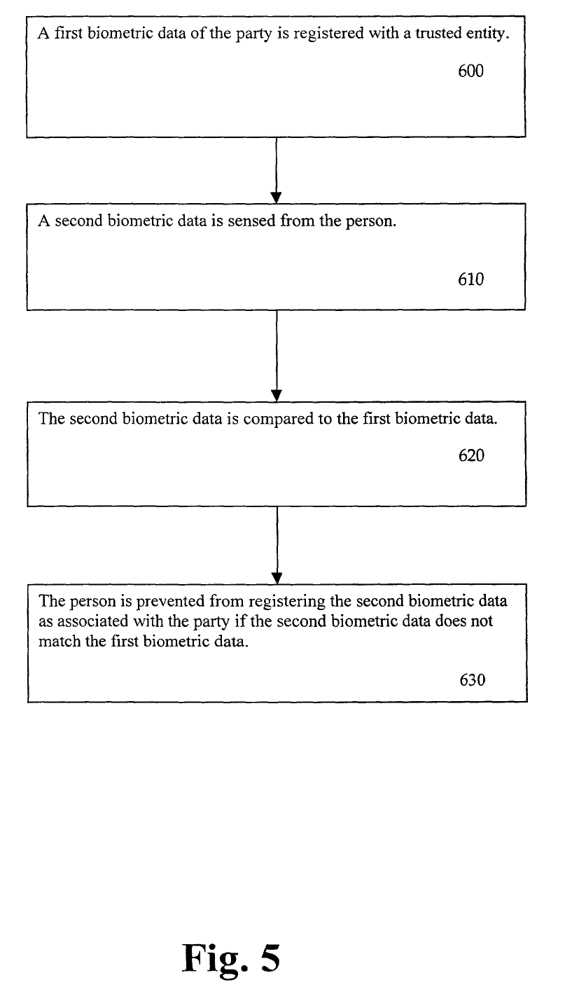

FIG. 5 illustrates a flow diagram of one method of preventing an unscrupulous person from improperly obtaining financial credit based upon an identity of a party. At block 600, a first biometric data of the party is registered with a trusted entity. At block 610, a second biometric data is sensed from the person. At block 620, the second biometric data is compared to the first biometric data. At block 630, the person is prevented from registering the second biometric data as associated with the party if the second biometric data does not match the first biometric data.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

It will be further appreciated that more or fewer processes may be incorporated into the method illustrated in FIG. 5 without departing from the scope of the invention and that no particular order is implied by the arrangement of blocks shown and described herein. It further will be appreciated that the method described in conjunction with FIG. 5 may be embodied in machine-executable instructions, e.g., software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic . . . etc.), as taking an action or causing a result. Such expressions are merely a shorthand way of saying that execution of the software by a computer causes the processor of the computer to perform an action or a produce a result.

What is claimed is:

1. A method comprising:
registering a first biometric data with a trusted entity;
sensing a second biometric data;
comparing the second biometric data to the first biometric data; and
preventing the registration of the second biometric data at the trusted entity as associated with an authorized user if the second biometric data does not match the first biometric data.

2. The method of claim 1, further comprising:
storing a copy of the first biometric data on a transaction device.

3. The method of claim 1, further comprising:
notifying in real-time one of a security entity and the authorized user of an unauthorized attempt to register the second biometric data.

4. The method of claim 1, further comprising:
accessing a financial account associated with the first biometric data if the first biometric data matches the second biometric data; and
transferring funds in real-time to a supplier.

5. The method of claim 4, further comprising:
withholding identifying information associated with the first biometric data from the supplier.

6. The method of claim 1, further comprising:
earmarking assets associated with the first biometric data and transferring the assets of the account in real-time to pay for one of a product and a service.

7. An article comprising:
a storage medium at a trusted entity including instructions stored thereon which when executed cause a digital system to perform a method including:
registering a first biometric data of a user with the trusted entity;
sensing a second biometric data from a person;
comparing the second biometric data to the first biometric data; and
preventing the person from registering the second biometric data at the trusted entity as associated with the user if the second biometric data does not match the first biometric data.

8. The article of claim 7, wherein the method further includes:
storing a copy of the first biometric data on a transaction device.

9. The article of claim 7, wherein the method further includes:
storing a copy of the first biometric data on one of a privacy card, a digital wallet, and a privacy card configured to be coupled to a digital wallet.

10. The article of claim 7, wherein the method further includes:
notifying in real-time one of a security entity and the user of an unauthorized attempt to register the second biometric data.

11. The article of claim 7, wherein the method further includes:
accessing a financial account of the person provided that the first biometric data matches the second biometric data; and
transferring funds in real-time to a supplier.

12. The article of claim 7, wherein the method further includes:
withholding an identification of the person from the supplier.

13. The article of claim 7, wherein the method further includes:
performing one of earmarking assets of the user and transferring assets of the account in real-time to pay for one of a product and a service.

14. A method of performing an electronic transaction using a transaction device comprising:
registering a first biometric data with a trusted entity in which the first biometric data is associated with a user;
storing a copy of the first biometric data on the transaction device;
providing the transaction device to the user;
sensing a second biometric data from a person;
comparing the second biometric data to the first biometric data stored on the transaction device;
authenticating the transaction provided that the second biometric data matches the first biometric data;
performing one of earmarking assets of the user and transferring assets of the account in real-time to pay for one of a product and a service; and
authorizing the electronic transaction.

15. The method of claim 14, further comprising:
notifying in real-time one of a security entity and the user of an unauthorized attempt to access financial credit of the user.

16. The method of claim 14, further comprising:
withholding an identification of the user from the supplier.

17. A system for preventing a person from improperly obtaining financial credit comprising:
a recording medium of a trusted entity configured to register a first biometric data of a user;
a processor, coupled to the recording medium, configured to store the first biometric data onto a transaction device and to prevent registration of a second biometric data that fails to match the first biometric data;
the transaction device comprising a chip configured to store the first biometric data and a sensor to sense the second biometric data from the person; and
means for preventing the person from improperly receiving financial credit if the person's second biometric data fails to match the first biometric data.

18. The system of claim 17, wherein the transaction device is selected from the group consisting of a privacy card, a digital wallet, and a privacy card configured to be coupled to a digital wallet.

19. The system of claim 17, wherein a party is electronically notified of an unauthorized use of the transaction device.

20. The system of claim 19, wherein the party is one of an owner of the transaction device and a security authority.

21. An electronic transaction device for use in a consumer purchasing system comprising:
a transaction device identifier providing no apparent identification of a user authorized to use the transaction device;
communication logic, disposed on a processor of the transaction device, configured to communicate the transaction device identifier to the system to perform a transaction, the system comprising a secure mechanism for correlating the device identifier and the user; and
security logic, disposed on a processor of the transaction device, configured to compare a registered first biometric data of an authorized user to a second biometric data read from a person attempting to use the transaction device.

22. The electronic transaction device of claim 21, wherein the transaction device is selected from the group consisting of a privacy card, a digital wallet, and a privacy card configured to be coupled to a digital wallet.

23. The electronic transaction device of claim 21, wherein the security logic that confirms an identification of an authorized user is selected from the group consisting of a PIN code and a fingerprint.

24. The electronic transaction device of claim 21, wherein the communication logic is selected from the group consisting of a smart card chip interface, contactless connection, magnetic stripe and wireless connection.
